(19) United States
(12) Patent Application Publication
(10) Pub. No.: US 2026/0063757 A1
(43) Pub. Date: Mar. 5, 2026

(54) RADAR SYSTEM

(71) Applicant: Robert Bosch GmbH, Stuttgart (DE)

(72) Inventors: Benedikt Loesch, Stuttgart (DE); Cornelius Kaiser, Rottenburg Am Neckar (DE); Johannes Fink, Karlsruhe (DE)

(21) Appl. No.: 19/295,757

(22) Filed: Aug. 11, 2025

(30) Foreign Application Priority Data
Aug. 28, 2024 (DE) 10 2024 208 184.1

(51) Int. Cl. G01S 7/35; G01S 13/58; G01S 13/931

(52) U.S. Cl. CPC G01S 7/356; G01S 13/584; G01S 13/931; G01S 2013/93271

(57) ABSTRACT

A radar system. The radar system has a transmitting and receiving device designed to transmit a transmission signal divided into frames which repeat over time, each frame containing at least one sequence of frequency ramps, and has a digital evaluation device configured to perform a Fourier transform at least in a distance dimension, frame by frame, on the received signal. The evaluation device is also configured to perform a parametric spectral estimation on the spectra obtained by the Fourier transform, in order to determine a Doppler frequency.

### CROSS REFERENCE

The present application claims the benefit under 35 U.S.C. § 119 of Germany Patent Application No. 10 2024 208 184.1 filed on Aug. 28, 2024, which is expressly incorporated herein by reference in its entirety.

### FIELD

The present invention relates to a radar system having a transmitting and receiving device designed to transmit a transmission signal divided into frames which repeat over time, each frame containing at least one sequence of frequency ramps, and having a digital evaluation device configured to perform a Fourier transform at least in a distance dimension, frame by frame, on the received signal.

In particular, the present invention relates to a radar system used in driver assistance systems of motor vehicles or in autonomous driving systems for sensing the traffic environment.

### BACKGROUND INFORMATION

In the case of conventional radar sensors of this type, for example in the case of LCS FMCW (linear chirp sequence frequency-modulated continuous-wave) systems, the transmission signals have a frame structure. During the duration of a frame, the signal is transmitted. After the transmitted frame, the transmitter pauses until the next frame is transmitted. The duration between the start of two successive frames is referred to as the cycle time. The ratio of frame duration and cycle duration is referred to as the duty cycle. Radar sensors according to the related art have frame durations of a few milliseconds to a few tens of milliseconds and a duty cycle of less than 50%, for example 20%.

The signal received by the radar sensor again after reflection on a radar target is mixed with a part of the transmission signal. Because there is a frequency difference between the reception signal and the transmission signal due to the ramp-like frequency modulation, which frequency difference is proportional to the signal propagation time to the radar target and back, the result obtained from the mixing is a beat signal whose frequency indicates, with close approximation, the distance of the radar target. If the radar target has a radial velocity relative to the radar sensor which is different from zero, the Doppler effect additionally results in a Doppler shift, which, however, can be neglected in the distance measurement if the ramp slope is sufficient. Over multiple transmitted frequency ramps, however, the Doppler shift results in a phase progression that allows relative velocity to be measured. The smallest velocity difference Av at which the radar echoes of two targets can still be distinguished as separate targets is referred to as the Doppler separation capability. This Doppler separation capability is inversely proportional to the coherent integration time, i.e., the time over which the successive frequency ramps are evaluated. Typically, the coherent integration time is equal to the frame duration. Thus, in order to improve the Doppler separation capability, frame durations as long as possible would be desirable. However, the frame duration cannot be increased by any desired amount, because, with increasing frame duration, the latency time which passes before the evaluation result is available in the driver assistance system and allows a driving response also increases. In addition, as the frame duration increases, the thermal load on the radar sensor also increases.

In principle, it is possible to increase the coherent integration time by continuing the evaluation over multiple frames. Since the frames are separated by pauses, the overall observation time is then so long that the velocity of the radar target can no longer be considered constant over this time and migration effects occur that must be compensated for by suitable transform, for example a keystone transform. Since the measurement data of a very large number of frequency ramps must be stored for the duration of the processing, there is a high memory requirement. In addition, this system also has a high latency, because processing cannot begin until all frames to be transformed have been received.

### SUMMARY

An object of the present invention is to improve the Doppler separation capability without increasing the latency and the memory requirement.

This object may be achieved according to the present invention in that the evaluation device is also configured to perform a parametric spectral estimation on the spectra obtained by the Fourier transform, in order to determine a Doppler frequency.

The term “parametric spectral estimation” refers to a class of conventional algorithmic methods by which it is possible to characterize a data sequence by certain parameters. If the data sequence represents a superposition of periodic signals having different frequencies, in particular the frequency components in the spectrum may be identified by a high-resolution parametric spectral estimation. According to an example embodiment of the present invention, the high-resolution parametric spectral estimation is used to determine the Doppler frequencies in the sequence of the successive frequency ramps. The advantage over non-parametric methods is in particular that the achievable resolution is not generally limited by the observation duration, so that, under certain circumstances, a better resolution of the estimation result is achieved in the case of the same measured values and the same observation duration. The spectral estimation may be carried out over multiple frames without the need to perform a data transformation on the measurement data.

Advantageous embodiments and further developments of the present invention will emerge from the disclosure herein.

Examples of suitable methods for high-resolution spectral include:
Multiple signal classification (MUSIC)
Estimation of signal parameters by rotational invariance techniques (ESPRIT)
Minimum norm method
High-order Yule-Walker and singular value decomposition
Nonlinear least squares method

In one example embodiment of the present invention, a two-dimensional digital Fourier transform in the distance dimension and the Doppler dimension is first carried out frame by frame as in conventional methods, so that a range-Doppler matrix is first obtained for each frame, i.e., a matrix which is divided into distance (range) cells and velocity (Doppler) cells and which indicates, in each cell, the complex amplitude of the reception signal for the particular combination of distance and velocity. At this stage, detection may already be performed to classify radar targets by distance and, albeit with low resolution, by velocity. According to the present invention, in a further step a parametric spectral estimation is then carried out over the mutually corresponding cells of the range-Doppler matrices for multiple successive frames in order to achieve a higher resolution in the Doppler dimension.

In an alternative example embodiment of the present invention, merely a Fourier transform in the distance dimension is performed frame by frame, i.e., a Fourier transform for each individual frequency ramp. The result then obtained is a set of distance vectors for each of the multiple frames. The spectral estimation is then carried out over the mutually corresponding components of the distance vectors and may also extend over multiple frames.

For radar sensors having multiple transmission antennas and/or multiple reception antennas, for example for a MIMO (multiple-input multiple-output) radar, the present invention may be combined with conventional methods for angle estimation, which are described, for example, in Germany Patent Application Nos. DE 10 2014 212 280 A1, DE 10 2014 212 284 A1 and DE 10 2017 200 317 A1. The parametric estimation may then also extend over several of the transmitting and receiving channels.

To facilitate resolution of ambiguities in the Doppler dimension, it may be expedient if the time intervals of the successive frequency ramps vary within a frame. Alternatively or additionally, the time intervals may also be varied from frame to frame.

Embodiment examples of the present invention are explained in more detail in the following with reference to the figures.

### BRIEF DESCRIPTION OF THE DRAWINGS

FIG. 1 shows a simplified block diagram of a radar system according to an example embodiment of the present invention.

FIG. 2 shows a block diagram of a measurement method implemented in the radar system according to FIG. 1.

FIG. 3 shows a block diagram of an alternative measurement method, according to an example embodiment of the present invention.

FIGS. 4 and 5 show flowcharts for illustrating the essential steps of the measurement methods according to FIGS. 2 and 3.

### DETAILED DESCRIPTION OF EXAMPLE EMBODIMENTS

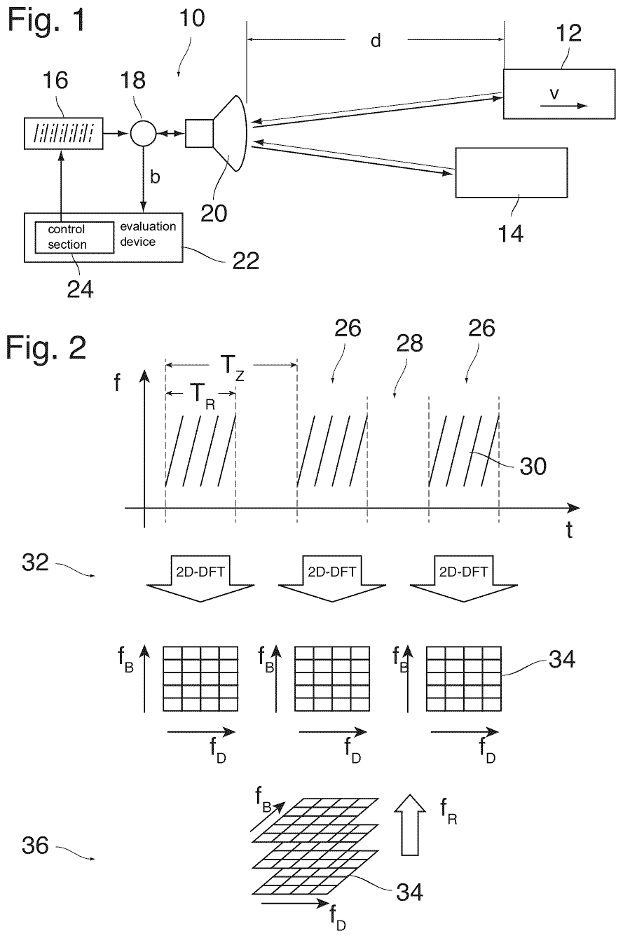

FIG. 1 shows a simplified block diagram of an FMCW radar sensor 10 that is installed at the front in a motor vehicle, for instance, and is used to measure distances d and relative velocities v of objects 12, 14, for example preceding vehicles. The radar sensor 10 comprises a voltage-controlled oscillator 16 that supplies a frequency-modulated transmission signal via a mixer 18 to a transmitting and receiving device 20 from which the signal is transmitted in the direction of the objects 12, 14. The signal reflected at the objects is received by the transmitting and receiving device 20 and mixed in the mixer 18 with a portion of the transmission signal. This results in a baseband signal b which is further evaluated in a digital evaluation device 22. The evaluation device 22 includes a control section 24 that controls the function of the oscillator 16. The frequency of the transmission signal supplied by the oscillator is modulated within a radar measurement with sequences of rising or falling ramps.

In FIG. 2 the frequency f of the transmission signal as a function of time t is shown in more detail. The transmission signal is divided into frames 26, which are separated from one another by pauses 28. Each individual frame has the duration Tᵣ. The time interval between two successive frames is the cycle time T_{z} and is equal to the sum of the frame duration and the duration of the pause 28.

Within each frame, the transmission signal consists of a series of linear frequency ramps 30. In the example shown, the frequency ramps 30 are equidistant within the frame and have the same slope and the same center frequency. In other embodiments, parameters such as slope, center frequency, and phase may be different from ramp to ramp. Likewise, the distances between the individual ramps may also vary. Furthermore, it is possible to transmit, within each frame, multiple nested frequency ramps which differ from one another in at least one parameter (Germany Patent Application No. DE 10 2014 212 280 A1).

In the evaluation device 22, the reception signals corresponding to the successive ramps 30 are subjected, frame by frame, to a two-dimensional Fourier transform 32. A Fourier transform in the distance dimension is performed on the signal of each individual ramp 30. A spectrum is obtained in which each located radar target is characterized by a peak at a particular frequency, the frequency position of which peak indicates the distance of the target. The second dimension of the two-dimensional Fourier transform is the so-called Doppler dimension. The Fourier integral is formed over the signals which are received in the various frequency ramps 30 of the sequence at mutually corresponding times. As a result, for each frame 26 a range-Doppler matrix 34 is obtained in which each cell stands for a particular combination of distance and velocity. The size of the cells corresponds to the resolution capability, which is determined in the distance dimension f_{B} primarily by the slope of the ramps 30 and in the Doppler dimension f_{D} primarily by the coherent integration time, which here is equal to the frame duration T_{R}. As soon as the range-Doppler matrix 34 is available for a single cell, a preliminary object detection may already be performed on this matrix. In a conventional way, those cells of the matrix in which the square amplitude of the received baseband signal b is above a suitable threshold value are identified. Stated differently, in the two-dimensional spectrum, those peaks that correspond to located radar targets are searched for.

As soon as the range-Doppler matrices 34 are available for a certain number of successive frames 26, a high-resolution parametric spectral estimation 36 takes place in a further evaluation stage. The range-Doppler matrices 34 obtained for the different frames 26 are placed on top of one another, figuratively speaking, and the spectral estimation takes place, in each case, for a column of matrix cells which extends in the third (frame) dimension f_{R}. For each combination of distance and velocity, the complex amplitudes entered in the individual cells then form the data sequence on which the spectral estimation is performed. If an object detection has already previously taken place, the spectral estimation may be limited to those cells in which a radar target has been located. This reduces computational effort considerably.

The spectral estimation for a selected column of matrix cells may be performed, for example, by eigenvalue decomposition of an autocorrelation matrix. The method is known as such and is only to be roughly outlined here.

If Q is the number of frames 26 selected for the estimation and K<Q is the number of frequency components to be estimated, then the entries in the selected matrix cells form a data sequence:

$$y ( q ) = {\sum }_{k = 1}^{K} {x}_{k} ( q ) + e ( q )$$

$${x}_{k} ( q ) = {a}_{k} exp ( j ( {w}_{k} q + {f}_{k} ) )$$

where q (=0, . . . , Q−1) is the index which counts the matrix cells, xₖ(q) is the complex amplitude of the k-th frequency component, e(q),=is a noise component, aₖ are the parameters to be estimated which indicate the amplitudes of the frequency components, j is the imaginary unit, and ωₖ and φₖ are the frequencies and phases of the frequency components.

With the help of a Q×K matrix A, y(q) can be written as:

$$y ( q ) = Ax ( q ) + e ( q )$$

Using the matrix A, the autocorrelation matrix R_{yy} can then be calculated under the assumption of uncorrelated noise.

$${R}_{yy} = {APA}^{*} + sI$$

Here, P is a diagonal matrix with K positive diagonal elements which indicates the power component of the signal, A* is the matrix which is adjoint to A, σ is the square root of the noise power, and I is the unit matrix.

An eigenvalue decomposition is then performed for the autocorrelation matrix R_{yy}, SO that a diagonal matrix with Q eigenvalues is obtained. The first K eigenvalues are greater than the noise power σ², while the remaining Q-K eigenvalues are equal to the noise power. The associated Q-dimensional eigenvectors are K signal space vectors s₁, . . . , s_{K} and Q-K noise space vectors g₁, . . . g_{Q-K}.

On the basis of the K greatest eigenvalues, the estimated signal space vectors and noise space vectors can then be calculated. The estimation of the K frequency components ω_{K} can then be performed, for example, using one of the parametric methods such as MUSIC, minimum norm or ESPRIT.

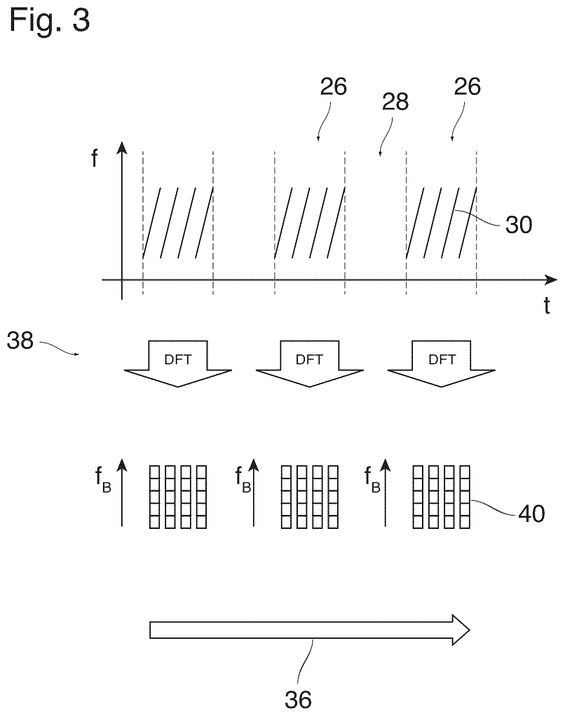

FIG. 3 shows a method variant in which a one-dimensional Fourier transform 38 in the distance dimension is performed instead of the two-dimensional Fourier transform 32. Thus, for each ramp 30, a vector 40 is obtained, the components of which are the complex amplitudes in the different distance cells. The high-resolution parametric spectral estimation 36 is performed here in the Doppler dimension. That is, the mutually corresponding components in the series of the vectors 40, which series may again extend over multiple frames 26, form in each case a data sequence on which the estimation is performed, so that high-resolution data in the Doppler dimension are obtained.

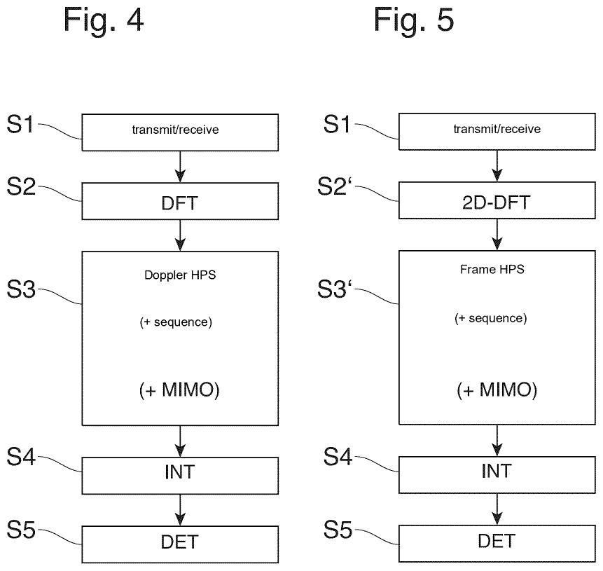

Essential steps of a method which corresponds to the procedure illustrated in FIG. 3 are indicated in FIG. 4. In step S1, the radar signals are transmitted, received, and digitized. In step S2, the one-dimensional discrete Fourier transform (DFT) 38 follows. In step S3, the high-resolution parametric spectral estimation (HPS) 36 in the Doppler dimension follows. If multiple, optionally nested, sequences of frequency ramps 30 are transmitted in each frame 26, the data obtained for the different sequences are also included in the estimation in step S3. In this way, a larger sample size and thus higher accuracy of the estimation are obtained. Accordingly, in the case of a MIMO radar, in step S3 a coherent parametric estimation over the multiple combinations of transmitting and receiving channels is also carried out.

If in step S3 multiple high-resolution spectra are obtained, for example for multiple MIMO channels, then these spectra are integrated non-coherently in a step S4. Finally, in step S5 the integration result is subjected to a high-resolution object detection in the Doppler dimension, optionally with resolution of ambiguities according to a conventional method.

FIG. 5 shows a flowchart for the method according to FIG. 2. The step S2 is replaced here by a step S2′ in which a two-dimensional digital Fourier transform is performed, 10 and the step S3 is replaced by a step S3′ in which the spectral estimation is carried out in the frame dimension, as well as optionally over different sequences and MIMO channels.

What is claimed is:

1. A radar system, comprising:
a transmitting and receiving device configured to transmit a transmission signal divided into frames which repeat over time, each frame containing at least one sequence of frequency ramps; and
a digital evaluation device configured to perform a Fourier transform at least in a distance dimension, frame by frame, on a received signal, and configured to perform a parametric spectral estimation on spectra obtained by the Fourier transform, to determine a Doppler frequency.

2. The radar system according to claim 1, wherein the spectral estimation is performed over data of multiple successive frames.

3. The radar system according to claim 2, wherein the digital Fourier transform is a two-dimensional Fourier transform in a distance dimension and a Doppler dimension, and wherein the parametric spectral estimation is performed in a frame dimension.

4. The radar system according to claim 2, wherein the digital Fourier transform is a one-dimensional transform in a distance dimension and wherein the parametric spectral estimation is performed in a Doppler dimension.

5. The radar system according to claim 1, wherein the signal transmitted within each frame includes multiple sequences of frequency ramps which differ in at least one parameter, and wherein the spectral estimation is performed based on data obtained for the multiple sequences.

6. The radar system according to claim 1, further comprising multiple transmitting and receiving channels, wherein the spectral estimation is performed based on spectra obtained for the multiple transmitting and receiving channels.
